(19) United States
(12) Patent Application Publication
(10) Pub. No.: US 2015/0295865 A1
(43) Pub. Date: Oct. 15, 2015

(54) ATTACHMENT TRANSFERRING METHOD, APPARATUS, AND SYSTEM

(71) Applicant: TENCENT TECHNOLOGY (SHENZHEN) COMPANY LIMITED, Shenzhen Guangdong (CN)

(72) Inventors: Jingcong Chen, Shenzhen Guangdong (CN); Junshan Wang, Shenzhen Guangdong (CN)

(73) Assignee: TENCENT TECHNOLOGY (SHENZHEN) COMPANY LIMITED, Shenzhen Guangdong (CN)

(21) Appl. No.: 14/750,751

(22) Filed: Jun. 25, 2015

Related U.S. Application Data
(63) Continuation of application No. PCT/CN2013/078907, filed on Jul. 5, 2013.

(30) Foreign Application Priority Data
Dec. 26, 2012 (CN) 201210575966.9

(51) Int. Cl. H04L 12/58; H04L 29/08

(52) U.S. Cl. CPC H04L 51/08; H04L 67/02

(57) ABSTRACT

An attachment transferring method, apparatus, and system, is described. Technical solutions are described that save traffic in a mobile client during transfer of an attachment of a network message, and improve transferring efficiency. The method may include parsing a first attachment message from a first mobile client, and sending an attachment obtained through parsing to a file server. The method may include sending a request for extracting the attachment to the file server according to a request message from a second mobile client for extracting the attachment. The method may include sending the attachment to the second mobile client.

### RELATED APPLICATION

The present application is a continuation application of PCT/CN2013/078907, filed on Jul. 5, 2013 and entitled “ATTACHMENT TRANSMISSION METHOD, DEVICE, AND SYSTEM”, which claims priority to Chinese Patent Application No. 201210575966.9, filed with the Chinese Patent Office on Dec. 26, 2012, and entitled “ATTACHMENT TRANSFERRING METHOD, APPARATUS, AND SYSTEM”, which are incorporated by reference in entirety.

### FIELD OF THE TECHNOLOGY

The present disclosure relates to the field of wireless communications technologies.

### BACKGROUND OF THE DISCLOSURE

An attachment can be transferred between a mobile client and a server during network communication between the mobile client and the server. For example, if a mobile client sends an attachment to a server, the mobile client first requests related information of the file server from a message server by using an instant messaging message, and sends the attachment to the file server according to the related information.

If the communication is based on Hyper Text Transfer Protocol (HTTP), an HTTP data packet header may be transmitted when an attachment is transferred between the mobile client and the file server. The data packet may consume a large amount of traffic in the mobile client, and bidirectional data exchange may be performed between the mobile client and the message server, and between the mobile client and the file server, which may lead to low data exchange efficiency.

### SUMMARY

Examples described throughout the present disclosure provide an attachment transferring method, apparatus, and system.

An example provides an attachment transferring method, including: parsing a first attachment message from a first mobile client, and sending an attachment obtained through parsing to a file server. The method may include sending a request for extracting the attachment to the file server according to a request message from a second mobile client for extracting the attachment. The method may also include sending the attachment to the second mobile client.

An example provides an attachment transferring apparatus. The apparatus may include a parsing unit to parse a first attachment message from a first mobile client. The apparatus may include a sending unit to send an attachment obtained through parsing by the parsing unit to a file server. The sending unit may send a request for extracting the attachment to the file server according to a request message from a second mobile client for extracting the attachment. The sending unit may send the attachment to the second mobile client.

An example provides an attachment transferring system. The system may include a first mobile client. The first mobile client may send a first attachment message to a message server. The first attachment message may carry an attachment. The message server may receive the first attachment message sent by the first mobile client, parse the first attachment message, and send the attachment obtained through parsing to a file server. The message server may receive a request message sent by a second mobile client for extracting the attachment, and send a request for extracting the attachment to the file server according to the request message for extracting the attachment, and send the attachment to the second mobile client. The file server may receive the attachment sent by the message server and save the attachment. The file server may receive the request sent by the message server for extracting the attachment, and send the attachment to the message server according to the request for extracting the attachment. The second mobile may send the request message for extracting the attachment to the message server, and receive the attachment sent by the message server.

An example provides a non-transitory computer readable storage medium, storing computer executable instructions. The instructions may include instructions to parse a first attachment message from a first mobile client, and send an attachment obtained through parsing to a file server. The instructions may include instructions to send a request for extracting the attachment to the file server according to a request message from a second mobile client for extracting the attachment. The instructions may include instructions to send the attachment to the second mobile client.

The examples described throughout the present disclosure provide technical solutions to technical problems. For example, a message server may send, to a file server, an attachment sent by a first mobile client. The message server may sends, when a second mobile client requests to extract the attachment, a request for extracting the attachment to the file server in response to the request from the second mobile client. The message server may send the extracted attachment to the second mobile client. Because the message server sends the attachment to the file server and extracts the attachment from the file server, the first mobile client and the second mobile client may not interact with the file server. Thus, an operation of a client is simplified and the efficiency of sending and extracting an attachment by the client is improved. In addition, an HTTP header may not be transmitted because the first mobile client and the second mobile client may not interact with the file server, thus, saving extra network traffic.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic structural diagram of an example attachment transferring system;

FIG. 2 is a schematic structural diagram of an example message supported by a message server;

FIG. 3 is a schematic flowchart of an example attachment transferring method;

FIG. 4 is a schematic flowchart of an example attachment transferring method;

FIG. 5 is a schematic structural diagram of an example attachment transferring apparatus;

FIG. 6 is a schematic structural diagram of an example attachment transferring apparatus;

FIG. 7 is a schematic structural diagram of an example attachment transferring apparatus; and

FIG. 8 is a schematic structural diagram of an example attachment transferring system.

### DESCRIPTION OF EMBODIMENTS

The examples described throughout the present disclosure provide technical solutions of an attachment transferring method, apparatus, and system, so as to save traffic in a mobile client during transferring of an attachment, and improve a success rate of the transferring.

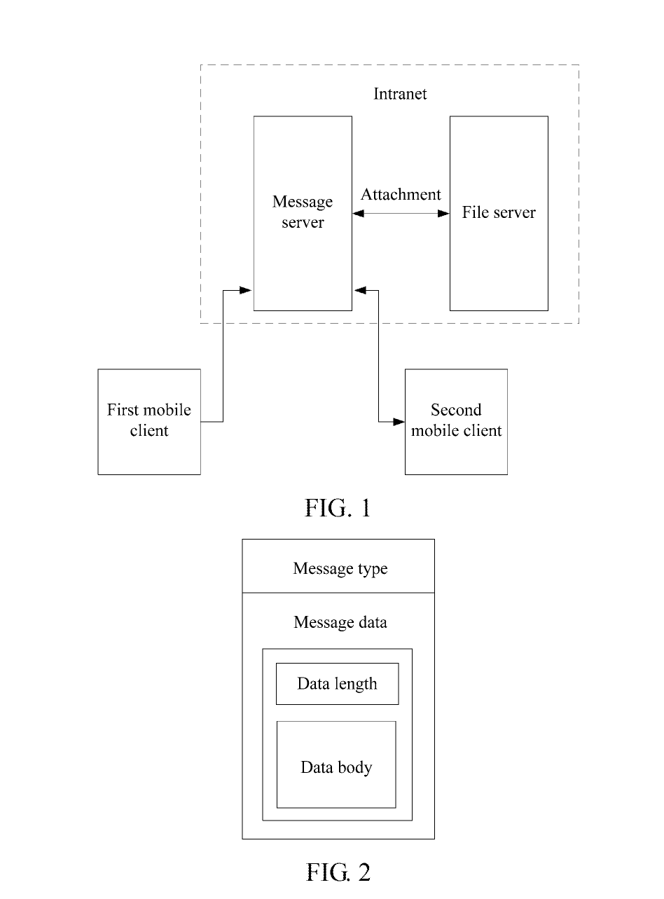

FIG. 1 is a schematic structural diagram of an example attachment transferring system. The system includes two types of servers, that is, a message server and a file server. The message server and the file server may be located in a same local area network. The message server needs to know an intranet Internet Protocol (IP) address, or a uniform/universal resource locator (URL) of the file server, and may be connected to the file server in an HTTP connection manner.

A TCP connection may be established between a mobile client that initiates instant messaging and the message server. The message server may provide a service related to account information of the mobile client, a login service of the mobile client, and a message forwarding service between the mobile client and another mobile client. In addition or alternatively, the mobile client may not know existence of the file server.

FIG. 2 is a schematic structural diagram of an example message supported by the message server. The message includes a message type and message data. The message type may be a common text message or an attachment message. The message data includes a data length and a data body. The message data varies with different message types, but messages of different message types may be obtained by serializing the text message or the attachment message. The message may contain other components than those described here.

A file server may perform communication by using HTTP, and provide attachment uploading and downloading services.

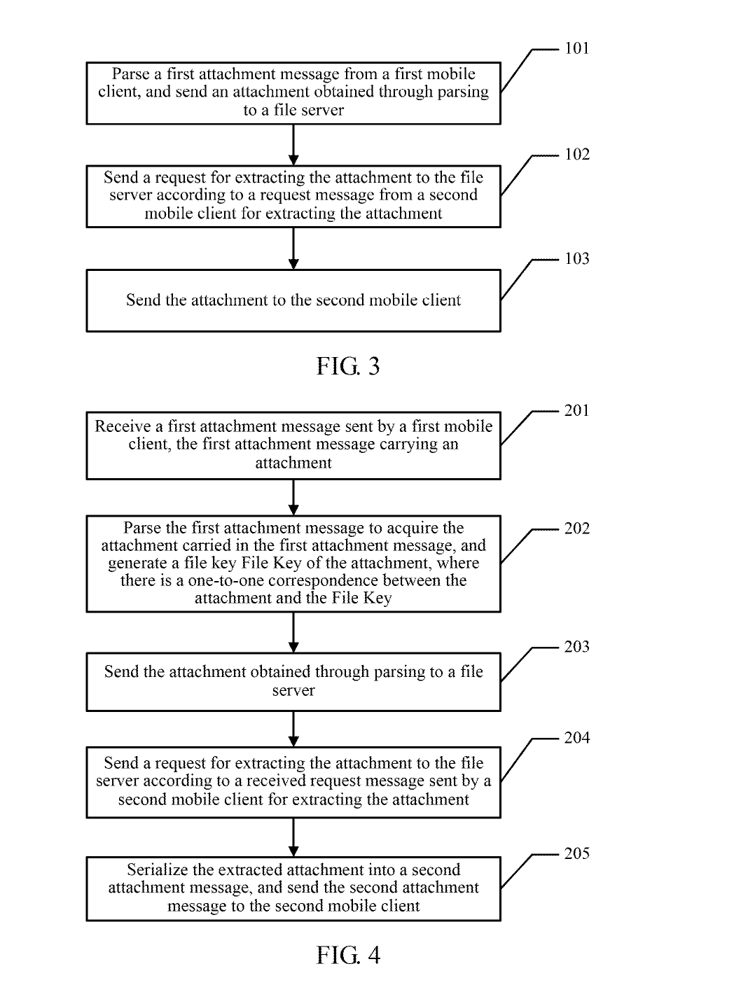

Referring to FIG. 3, an example attachment transferring method may include at least step 101 to step 103.

In step 101, a first attachment message from a first mobile client is parsed, and an attachment obtained through parsing is sent to a file server.

For example, a message server may receive, by using a pre-established Transmission Communication Protocol (TCP) connection, the first attachment message sent by the first mobile client. The first attachment message may carry the attachment. The attachment may be a file sent along with the first attachment message, and may include a picture, an audio file, a video file, or a file of another type.

The message server may be connected to the file server by using HTTP. The message server may parse the received attachment message, and send the attachment obtained through parsing to the file server. The file server may save the attachment.

In step 102, a request for extracting the attachment may be sent to the file server according to a request message from a second mobile client for extracting the attachment.

For example, the message server may receive the request message sent by the second mobile client for extracting the attachment. The message server may send the request for extracting the attachment to the file server according to the received request message for extracting the attachment.

In step 103, the attachment may be sent to the second mobile client.

For example, the message server may receive the extracted attachment sent by the file server, and may serialize the extracted attachment into a second attachment message and send the second attachment message to the second mobile client.

For example, the first mobile client that sends the attachment and the second mobile client that extracts the attachment may be the same mobile client.

In another example, the message server may send an attachment from the first mobile client to the file server. The message server may send, in response to a request to extract the attachment from the second mobile client, a request for extracting the attachment to the file server. The message server may send the request to the file server according to the request message from the second mobile client. The message server may send the extracted attachment to the second mobile client. Since the message server sends the attachment to the file server and extracts the attachment from the file server, the first mobile client and the second mobile client do not need to interact with the file server. Thus, the operation of the clients is simplified and the efficiency of sending and extracting an attachment by the clients is improved. In addition, the clients may avoid transmission of an HTTP header because the first client and the second client do interact with the file server. Thus, additional saving in traffic may be achieved.

Referring to FIG. 4, an example attachment transferring method may include step 201 to step 205.

In step 201, The first mobile client may receive a first attachment message to be sent to the message server. The first attachment message may be a message, such as an instant messenger message, an email message or any other network communication message that includes an attachment. The attachment may be a picture, a video, an audio, a text, or any other type of file.

Before sending the first attachment message to the message server, the first mobile client may serialize the attachment and save the serialized attachment into a “Data body” field in the attachment message. The first mobile client may calculate a data length after serialization and save the calculated data length into a “Data length” field in the first attachment message. The first mobile client may save a message type into a “Message Type” field. The first mobile client may send the first attachment message that has been processed as above to the message server.

In step 202, the first attachment message is parsed to acquire the attachment carried in the first attachment message. A file key corresponding to the attachment may be generated. There may be a one-to-one correspondence between the attachment and the file key.

The message server may parse each field in the first attachment message to acquire the attachment carried in the first attachment message. The message server may generate the file key. For example, the file key of the attachment may be based on a hash algorithm. For example, the message server may analyze the attachment by using a message digest algorithm 5 (MD5), to generate a unique File Key.. For example, the attachment may be numbered, and the one-to-one correspondence between the number of the attachment and the file key may be recorded, where the file key is a unique identifier used for identifying the attachment.

The message server may save all other message fields except the “Data length” and the “Data body.”

In step 203, the attachment obtained through parsing may be sent to the file server.

For example, the message server may communicate with the file server using HTTP. The message server may send the attachment to the file server by using a POST request, where a parameter of the POST request includes the file key corresponding to the attachment. The file server may save the attachment and save the correspondence between the attachment and the file key.

The POST request is a manner for submission in a web form for uploading files, where the parameter of the request is included in HTTP BODY.

The message server may send the correspondence between the attachment and the file key to a mobile client in an access network. For example, a correspondence between the number of the attachment and the file key may be sent to the mobile client in the access network, so that when the mobile client in the network requests, from the message server, to acquire the attachment, it only needs to carry information related to the attachment in the request, such as the number of the attachment. The message server can identify, according to the correspondence, the file key corresponding to the attachment requested by the mobile client.

In step 204, a request for extracting the attachment is sent to the file server according to a received request message sent by the second mobile client for extracting the attachment.

After receiving the request message sent by the second mobile client for extracting the attachment, the message server may read the request message. The message server may identify, according to the information about the attachment in the request message, the attachment to be acquired by the second mobile client. The message server may search for and find the file key corresponding to the attachment according to the correspondence between the attachment and the file key. The message server may use the file key as a parameter of a GET request, and send the GET request to the file server, so as to extract the attachment.

The GET request is a manner for submission in a web form, and submits data by using a URL, where a parameter of the request is included in the URL.

In step 205, the extracted attachment may be serialized into a second attachment message. The second attachment message may be sent to the second mobile client.

The message server may serialize the attachment extracted from the file server, and save the serialized attachment into a “Data body” field in the second attachment message. The second attachment message may be used for sending the extracted attachment to the second mobile client.

The message server may further calculate a data length in the second attachment message, and save the calculated data length into a “Data length” field in the second attachment message. The message server may send the second attachment message that has been processed as above to the second mobile client. After receiving the second attachment message, the second mobile client may parse the second attachment message to obtain the attachment carried in the second attachment message.

In an example, the message server may parse the attachment message sent by the first mobile client to acquire the attachment carried in the first attachment message. The message server may generate the File Key corresponding to the attachment, and upload the attachment to the file server by using a POST request. A parameter of the POST request may include the File Key, so that the file server may save the attachment and a correspondence between the attachment and the File Key. When the second mobile client requests to extract the attachment, the File Key is found according to the attachment and the correspondence. The File Key may then be used as a parameter of a GET request, and the GET request is sent to the file server, so as to extract the attachment. Thus, the message server sends the attachment to the file server and extracts the attachment from the file server, without any interaction of the first mobile client and the second mobile client with the file server. Accordingly, an operation of the clients may be simplified and the efficiency of sending and extracting an attachment by the clients may be improved. In addition, the clients may avoid sending extra data such as an HTTP header because the first mobile client and the second mobile client do not interact with the file server.

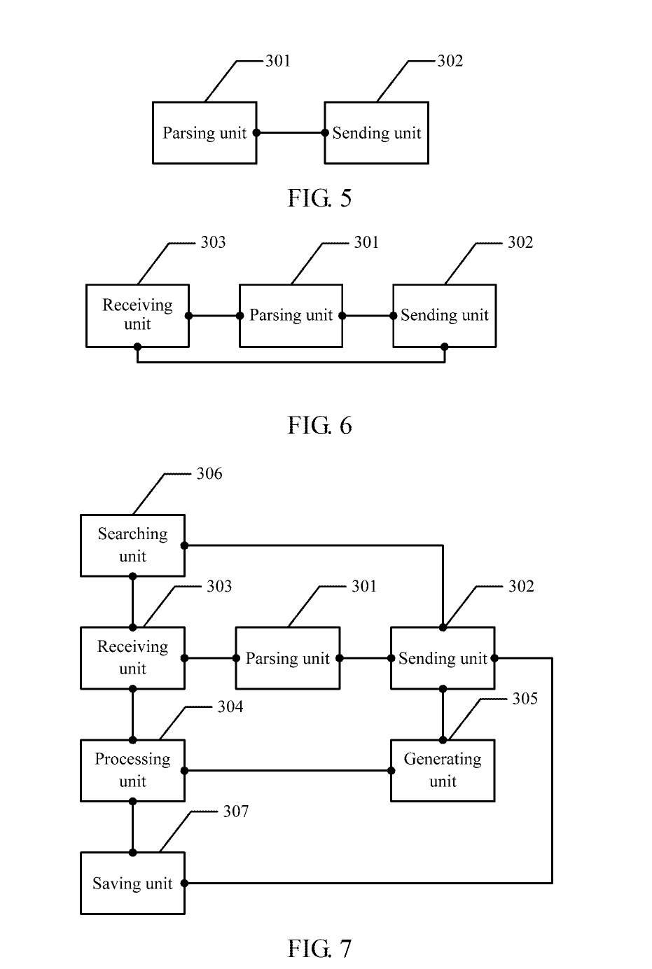

Referring to FIG. 5, an example attachment transferring apparatus may include a parsing unit 301 and a sending unit 302. The parsing unit 301 may parse the first attachment message from the first mobile client. The sending unit 302 may send the attachment to the file server. The sending unit 302 may send a request for extracting the attachment to the file server according to a request message from the second mobile client for extracting the attachment. The sending unit 302 may send the extracted attachment to the second mobile client.

The attachment transferring apparatus may implement the methods described throughout the present disclosure such as that shown in FIG. 3.

In an example, the sending unit 302 may send an attachment from the first mobile client to the file server. The sending unit 302 may send, when the second mobile client requests to extract the attachment, a request for extracting the attachment to the file server according to the request message of the second mobile client for extracting the attachment. The sending unit 302 may send the extracted attachment to the second mobile client. Thus, the message server may send the attachment to the file server and extract the attachment from the file server. The first mobile client and the second mobile client may not interact with the file server. Therefore, operation of the clients may be simplified and the efficiency of sending and extracting the attachment by the clients may be improved. In addition, the clients may not transmit an HTTP header because the first mobile client and the second mobile client may not interact with the file server, so that network traffic can be conserved.

Referring to FIG. 6, the attachment transferring apparatus as that described elsewhere in the present disclosure, may include a receiving unit 303.

The receiving unit 303 may receive the first attachment message from the first mobile client. The attachment message may include the attachment.

The parsing unit 301 may parse the first attachment message received by the receiving unit 303, and the sending unit 302 may send the attachment obtained through parsing to the file server.

The receiving unit 303 may receive the request message from the second mobile client for extracting the attachment.

The sending unit 302 may send the request for extracting the attachment to the file server according to the request received by the receiving unit 303 from the second mobile client.

In another example, as shown in FIG. 7, the attachment transferring apparatus may further include a processing unit 304 to acquire the attachment carried in the first attachment message. The attachment transferring apparatus may further include a generating unit 305 to generate the File Key of the attachment. The attachment and the File Key may have a one-to-one correspondence.

The sending unit 302 may send the attachment to the file server by using a POST request, where a parameter of the POST request includes the File Key, so that the file server saves the attachment and the correspondence between the attachment and the File Key.

The receiving unit 303 may receive the request sent by the second mobile client for extracting the attachment. The request of the second mobile client may contain information about the requested attachment.

A searching unit 306 may find the File Key according to information about the attachment that is carried in the request received by the receiving unit 303 for extracting the attachment, and the correspondence between the attachment and the File Key.

The sending unit 302 may use the File Key as a parameter of a GET request, and send the GET request to the file server, so as to extract the attachment.

The processing unit 304 may serialize the extracted attachment into a second attachment message, and calculate a data length of the second attachment message.

A saving unit 307 may save, into a “Data body” field in the second attachment message, the attachment serialized by the processing unit 304.

The saving unit 307 may save the data length calculated by the processing unit 304 into a “Data length” field in the second attachment message.

The sending unit 302 may send the second attachment message to the second mobile client.

The attachment transferring apparatus may implement the methods described throughout the present disclosure such as those in FIG. 3 and FIG. 4.

In an example, the processing unit 304 may acquire the attachment carried in the first attachment message. The generating unit 305 may generate the File Key corresponding to the attachment. There may be a one-to-one correspondence between the attachment and the File Key. The sending unit 302 may send the attachment to the file server by using a POST request. A parameter of the POST request includes the File Key, so that the file server saves the attachment and the correspondence between the attachment and the File Key. The receiving unit 303 may receive the request message from the second mobile client. The searching unit 306 finds the File Key according to information about the attachment carried in the request message and the correspondence between the attachment and the File Key. The sending unit 302 may use the File Key as a parameter of a GET request, and send the GET request to the file server, so as to extract the attachment. Accordingly, the message server may send the attachment to the file server and extracts the attachment from the file server without any interaction of the first mobile client and the second mobile client with the file server. Thus, an operation of the clients may be simplified and the efficiency of sending and extracting an attachment by the clients is improved. In addition, the clients may not transmit an HTTP header, and conserve additional network traffic.

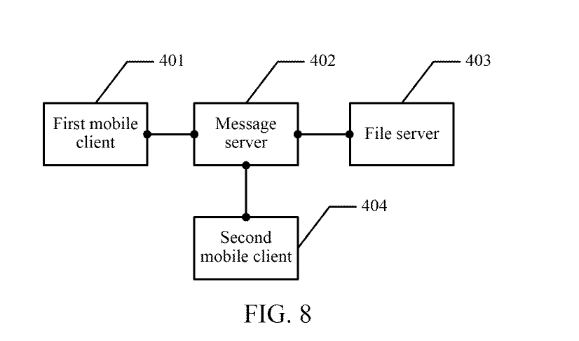

FIG. 8 illustrates an example attachment transferring system. The system may include a first mobile client 401, a message server 402, a file server 403, and a second mobile client 404.

The first mobile client 401 may send the first attachment message to the message server 402. The first attachment message may carry the attachment.

The message server 402 may receive the first attachment message sent by the first mobile client 401. The message server 402 may parse the first attachment message, and send the attachment to the file server 403. The message server 402 may receive a request message sent by the second mobile client 404 for extracting the attachment and, in response, send a request for extracting the attachment to the file server 403. The request sent to the file server 403 may be based on the request message from the second mobile client 404. The message server 402 may send the extracted attachment to the second mobile client 404.

The file server 403 may receive the attachment sent by the message server 402 and save the attachment. The file server 403 may receive the request sent by the message server 402 for extracting the attachment, and send the attachment to the message server 402 according to the request for extracting the attachment.

The second mobile client 404 may send the request for extracting the attachment to the message server 402, and receive the attachment sent by the message server 402.

The attachment transferring system described may implement methods described throughout the present disclosure.

In addition, in an aspect, the technical solutions described throughout the present disclosure may be provided as a program product storing machine readable and executable instruction code. When the instruction code is read and executed by a machine, the attachment transferring method described throughout the present disclosure can be implemented by hardware. Correspondingly, various storage media used for bearing the program product, such as a magnetic disk, an optical disc, a magneto-optical disk, and a semiconductor memory, are also included in the disclosure of the present disclosure.

The foregoing machine readable storage media include, but are not limited to, various memories and storage units, a semiconductor device, a magnetic disk unit such as an optical disc, a magnetic disk and a magneto-optical disk, and other media suitable for storing information.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various components and screen display functionality is but one example of such functionality and any other configurations encompassing similar functionality are possible.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof ” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N.

In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. An attachment transferring method, comprising:
parsing a first attachment message from a first mobile client, and sending an attachment obtained through parsing to a file server;
sending a request for extracting the attachment to the file server according to a request message from a second mobile client for extracting the attachment; and
sending the attachment to the second mobile client.

2. The method according to claim 1, wherein the parsing the first attachment message from the first mobile client comprises:
receiving the first attachment message sent by the first mobile client;
parsing the first attachment message to acquire the attachment carried in the first attachment message; and
generating a file key File Key corresponding to the attachment.

3. The method according to claim 2, wherein sending the attachment obtained through parsing to the file server comprises:
sending the attachment to the file server by using a POST request, wherein the POST request comprises the File Key, wherein the file server saves the attachment corresponding to the File Key.

4. The method according to claim 2, wherein sending the request for extracting the attachment to the file server according to the request message from the second mobile client for extracting the attachment comprises:
receiving the request message sent by the second mobile client for extracting the attachment; identifying the File Key in the request message for extracting the attachment based on the attachment corresponding to the File Key; and
using the File Key as a parameter of a GET request, and sending the GET request to the file server, so as to extract the attachment.

5. The method according to claim 3, wherein sending the request for extracting the attachment to the file server according to the request message from the second mobile client for extracting the attachment comprises:
receiving the request message sent by the second mobile client for extracting the attachment;
identifying the File Key in the request message for extracting the attachment based on the attachment corresponding to the File Key; and
using the File Key as a parameter of a GET request, and sending the GET request to the file server, so as to extract the attachment.

6. The method according to claim 1, wherein sending the attachment to the second mobile client comprises:
serializing the attachment, and saving the serialized attachment into a data body field in a second attachment message;
calculating a data length of the second attachment message, and saving the data length into a data length field of the second attachment message; and
sending the second attachment message to the second mobile client.

7. An attachment transferring apparatus, comprising:
a parsing unit configured to parse a first attachment message from a first mobile client; and
a sending unit configured to:
send an attachment obtained through parsing by the parsing unit to a file server;
send a request for extracting the attachment to the file server according to a request message from a second mobile client for extracting the attachment; and
send the attachment to the second mobile client.

8. The apparatus according to claim 7, further comprising:
a receiving unit configured to:
receive the first attachment message from the first mobile client, wherein the attachment message carries the attachment; and
receive the request message from a second mobile client for extracting the attachment.

9. The apparatus according to claim 8, further comprising:
a processing unit configured to acquire the attachment carried in the first attachment message; and
a generating unit configured to generate a file key corresponding to the attachment.

10. The apparatus according to claim 9, wherein
the sending unit is further configured to send the attachment to the file server by using a POST request, wherein the POST request comprises the file key.

11. The apparatus according to claim 9, further comprising:
a searching unit configured to find the file key according to information about the attachment that is carried in the request message received by the receiving unit for extracting the attachment, and the attachment corresponding to the file key.

12. The apparatus according to claim 10, further comprising:
a searching unit, configured to find the file key according to information about the attachment that is carried in the request message received by the receiving unit for extracting the attachment, and the attachment corresponding to the file key.

13. The apparatus according to claim 11, wherein
the sending unit is further configured to use the file key as a parameter of a GET request, and send the GET request to the file server, so as to extract the attachment.

14. The apparatus according to claim 12, wherein
the sending unit is further configured to use the file key as a parameter of a GET request, and send the GET request to the file server, so as to extract the attachment.

15. The apparatus according to claim 9, wherein
the processing unit is further configured to serialize the attachment into a second attachment message, and calculate a data length in the second attachment message.

16. The apparatus according to claim 15, further comprising:
a saving unit configured to:
save, into a data body field in the second attachment message, the attachment serialized by the processing unit; and
save the data length calculated by the processing unit into a data length field in the second attachment message.

17. A non-transitory computer readable storage medium storing computer executable instructions, the non-transitory computer readable storage medium comprising:
instructions to parse a first attachment message from a first mobile client, and send an attachment obtained through parsing to a file server;
instructions to send a request for extracting the attachment to the file server according to a request message from a second mobile client for extracting the attachment; and
instructions to send the attachment to the second mobile client.
